(19) United States
(12) Patent Application Publication
(10) Pub. No.: US 2013/0120468 A1
(43) Pub. Date: May 16, 2013

(54) Four-Primary Color Display Device and Method for Calculating Relative Brightness of Fourth Primary Color

(71) Applicants: Pei-Lin Hsieh, Taoyuan County (TW); Hsiang-Tan Lin, Keelung City (TW)

(72) Inventors: Pei-Lin Hsieh, Taoyuan County (TW); Hsiang-Tan Lin, Keelung City (TW)

(73) Assignee: CHUNGHWA PICTURE TUBES, LTD., Bade City (TW)

(21) Appl. No.: 13/476,630

(22) Filed: May 21, 2012

(30) Foreign Application Priority Data
Nov. 11, 2011 (TW) 100141277

(51) Int. Cl. G09G 5/10

(52) U.S. Cl. 345/690

(57) ABSTRACT

A four-primary color display device and a method for calculating relative brightness of a fourth primary color are provided. The display device includes plural pixels and a relative brightness computation module of the fourth primary color for calculating relative brightness of that color. The pixel has at least four sub-pixels for displaying red, green, blue and the fourth primary color respectively. The relative brightness computation module of the fourth primary color includes a basic value computation unit, a gain value computation unit, a weighting proportion computation unit and a relative brightness computation unit of the fourth primary color.

### RELATED APPLICATIONS

This application claims priority to Taiwan Application Serial Number 100141277, filed Nov. 11, 2011, which is herein incorporated by reference.

### BACKGROUND

1. Technical Field

The present invention relates to a four-primary color display device and a method for calculating relative brightness of a fourth primary color.

2. Description of Related Art

A conventional four-primary color display device adopts the minimum value among relative brightnesses of red, green and blue primary colors as a relative brightness of a fourth primary color, for thereby maintaining a saturation of an image itself. However, it is difficult for a viewer to clearly recognize the image under a circumstance of strong ambient light or low backlight. The reason why the viewer is unable to clearly recognize the image is, under the strong ambient light, that the ambient light reflects from the panel and decreases the image contrast. Also, the strong ambient light reduces the sensitivity of the viewer's eyes, so as not to clearly recognize the image displayed.

In addition, while the display device is entering a power saving mode, the overall level of the backlight brightness is decreased and thus the viewer is apt to feel that the image is too dark to be clearly recognized.

In order to solve the above-mentioned problems, the relative brightness of the fourth primary color may increase to raise the whole brightness. However, the image contrast is thereby decreased, and the viewer is still apt to feel that the image is blurred and not easy to be recognized.

Accordingly, it is necessary for a four-primary color display device and a method for calculating relative brightness of a fourth primary color to exhibit good readability under the circumstances of strong ambient light or low backlight.

### SUMMARY

One purpose of the present invention is to enhance readability of a four-primary color display device under conditions of strong ambient light or low backlight. Relative brightness of a fourth primary color may be adjusted according to relative brightness of red, green and blue primary colors, and ambient brightness or backlight brightness. Therefore, image brightness may be appropriately increased under different ambient brightness or backlight brightness such that the four-primary color display device is capable of exhibiting excellent readability whether under strong ambient light or low backlight.

One aspect of the present invention provides a four-primary color display device, which includes plural pixels and a relative brightness computation module of a fourth primary color for calculating relative brightness of that color. Each of the pixels has four sub-pixels for displaying red, green, blue and the fourth primary colors respectively. The relative brightness computation module of the fourth primary color includes a basic value computation unit, a gain value computation unit, a weighting proportion computation unit and a relative brightness computation unit of the fourth primary color. The basic value computation unit is used to select a minimum value from relative brightness of red, green and blue primary colors, in which the minimum value is acted as a basic value. The gain value computation unit is used to calculate a gain value according to the relative brightness of the red, the green and the blue primary colors. The weighting proportion computation unit is used to determine a weighting proportion of the basic value and the gain value according to ambient brightness or backlight brightness. A relative brightness computation unit of the fourth primary color is used to calculate the relative brightness of the fourth primary color according to the basic value, the gain value and the weighting proportion.

Another aspect of the present invention provides a method for calculating relative brightness of a fourth primary color, which includes steps described below. A basic value is calculated, in which it is a minimum value of the relative brightness of red, green and blue primary colors. A gain value is calculated according to the relative brightness of the red, the green and the blue primary colors. A weighting proportion of the basic value and the gain value are determined according to ambient brightness or backlight brightness. The relative brightness of the fourth primary color is calculated according to the basic value, the gain value and the weighting proportion.

### BRIEF DESCRIPTION OF THE DRAWINGS

The invention may be more fully understood by reading the following detailed description of the embodiment, with reference made to the accompanying drawings as follows:

FIG. 1 is a schematic diagram of a four-primary color display device according to one embodiment of the present invention;

FIG. 2 is a functional block diagram of a relative brightness computation module of a fourth primary color according to one embodiment of the present invention;

FIG. 3 is a relationship diagram between the image brightness value and the gain value according to one embodiment of the present invention;

FIG. 4 is a relationship diagram between the ambient brightness and the weighting proportion according to one embodiment of the present invention; and

FIG. 5 is a relationship diagram between the backlight brightness and the weighting proportion according to one embodiment of the present invention.

### DETAILED DESCRIPTION

The present invention is described by the following specific embodiments. Those with ordinary skill in the arts can readily understand the other advantages and functions of the present invention after reading the invention of this specification. The present invention can also be implemented with different embodiments. Various details described in this specification can be modified based on different viewpoints and applications without departing from the scope of the present invention.

Reference will now be made in detail to the present embodiments of the invention, examples of which are illustrated in the accompanying drawings. Wherever possible, the same reference numbers are used in the drawings and the description to refer to the same or like parts.

An embodiment of the present invention is to solve poor readability of typical display devices under conditions of strong ambient light or low backlight. A four-primary color display device and a method for calculating relative brightness of a fourth primary color are developed to thereby appropriately increase image brightness under different ambient brightness or backlight brightness. Accordingly, such display device is capable of exhibiting good readability whether under strong ambient light or low backlight.

An embodiment of the present invention provides a four-primary color display device, which includes plural pixels and a relative brightness computation module of the fourth primary color for calculating the relative brightness of that color.

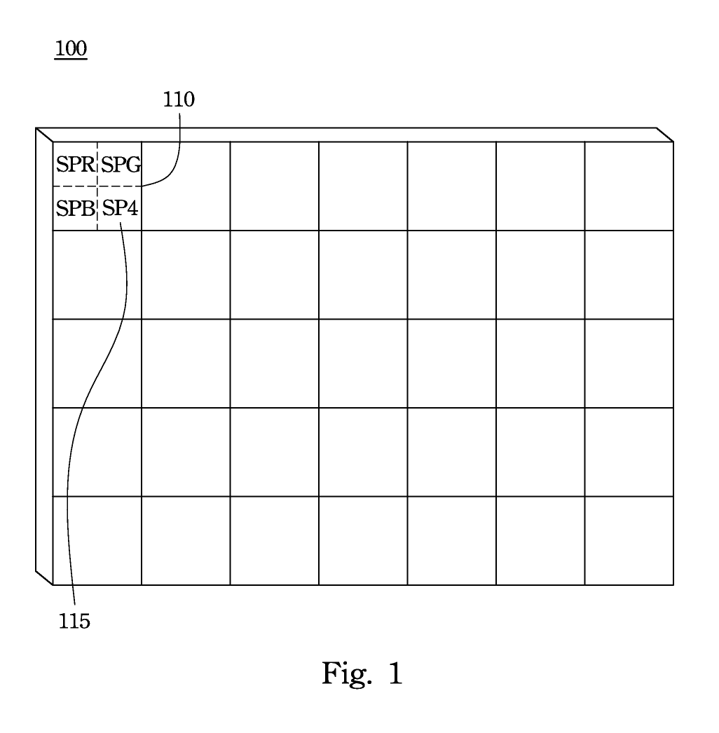

FIG. 1 is a schematic diagram of a four-primary color display device according to one embodiment of present invention. The four-primary color display device 100 includes plural pixels 110. Each of the pixels 110 is composed of four sub-pixels 115, which are a red sub-pixel (SPR), a green sub-pixel (SPG), a blue sub-pixel (SPB), and a fourth primary color sub-pixel (SP4) for displaying red, green, blue and the fourth primary colors. The four-primary color display device may be a flat panel display device such as a liquid crystal display device. The term “three primary colors” described below refers to red, green and blue primary colors. In several embodiments, the fourth primary color may be a white primary color, a cyan primary color, a yellow primary color or a magenta primary color.

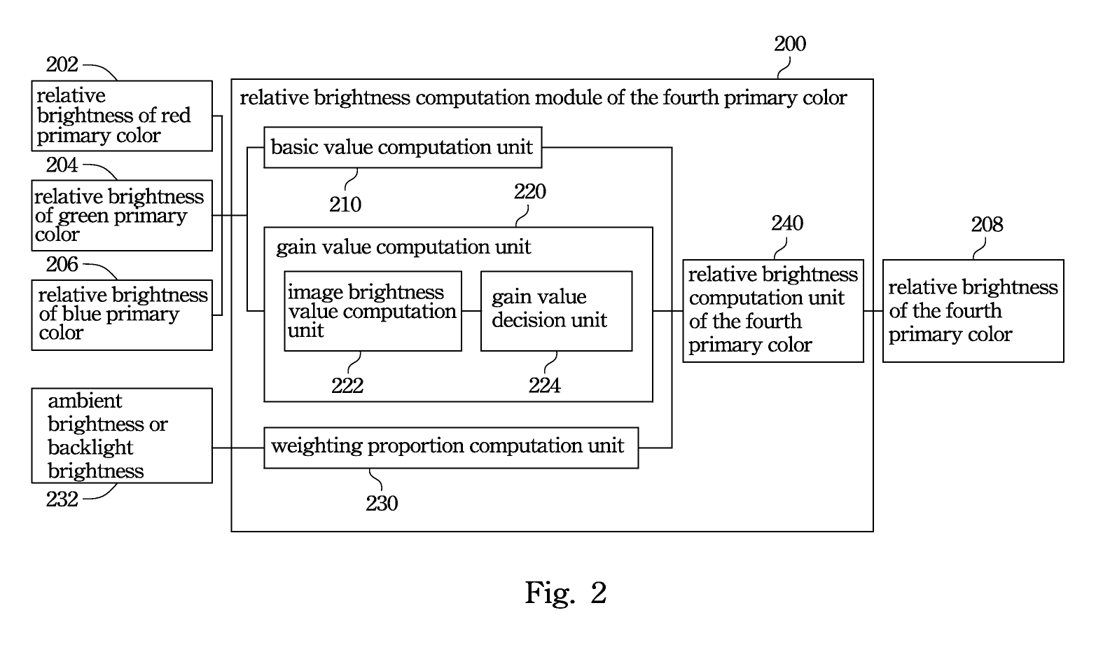

FIG. 2 is a functional block diagram of a relative brightness computation module of a fourth primary color according to one embodiment of the present invention. The relative brightness computation module of the fourth primary color 200 includes a basic value computation unit 210, a gain value computation unit 220, a weighting proportion computation unit 230 and a relative brightness computation unit of the fourth primary color 240. Relative brightness of the red primary color 202, relative brightness of the green primary color 204, relative brightness of the blue primary color 206, and ambient brightness or backlight brightness 232 may be input to the relative brightness computation module of the fourth primary color 200, and relative brightness of the fourth primary color 208 may be then output from that module.

The relative brightness of the red primary color 202, the relative brightness of the green primary color 204, the relative brightness of the blue primary color 206, and the relative brightness of the fourth primary color 208 may be gray level values of the red, the green, the blue, and the fourth primary colors in the range of 0 to 255.

A basic value computation unit 210 is provided for selecting a minimum value from the inputting relative brightness of the red primary color 202, the relative brightness of the green primary color 204 and the relative brightness of the blue primary color 206, in which that value is served as a basic value. The basic value is chose from the minimum value of the inputting relative brightness of the three primary colors in order to maintain a saturation of an image itself.

A gain value computation unit 220 is use for calculating a gain value according to the inputting relative brightness of the three primary colors. The purpose is to increase brightness and an image contrast ratio.

In one embodiment, the gain value computation unit 220 may include an image brightness value computation unit 222 and a gain value decision unit 224.

The image brightness value computation unit 222 may be employed to calculate an image brightness value according to a brightness ratio of the three primary colors. The image brightness value is then input to the gain value decision unit 224 for determining the gain value. As an example, the brightness ratio of the red, the green and the blue primary colors is about 3:6:1. Thus, in one embodiment, the image brightness value computation unit 222 may calculate the image brightness value according to Y=(3R+6G+B)/10. Y represents the image brightness value. R, G and B represent the relative brightness of the red primary color 202, the relative brightness of the green primary color 204, and the relative brightness of the blue primary color 206 respectively. The calculated image brightness value can be regarded as an average brightness of the relative brightness of the three primary colors as far as three sub-pixels are concerned.

A gain value decision unit 224 is employed to determine the gain value according to the image brightness value. The gain value becomes higher as the image brightness value becomes higher. The relationship between the image brightness value and the gain value may be linear or non-linear.

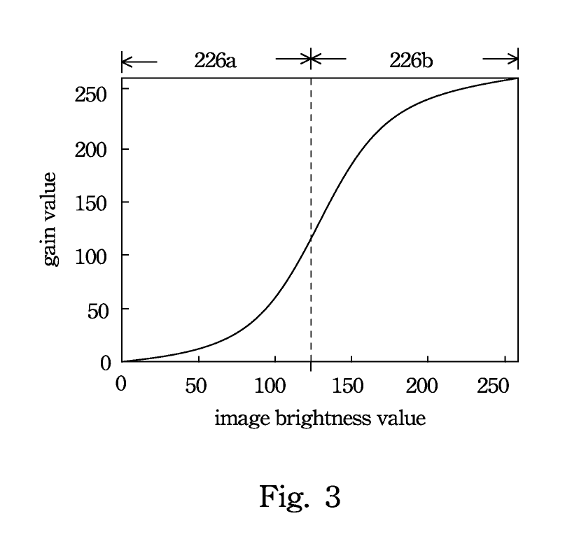

In one embodiment, a relationship diagram between the image brightness value and the gain value is a non-linear sigmoid curve, as depicted in FIG. 3. Both a darkening region 226a and a brightening region 226b in FIG. 3 are used to enhance a contrast ratio of an image. Specifically, a gain value in the brightening region 226b, which is determined from a high image brightness value calculated according to the relative brightness of the three primary colors, is higher than that image brightness value. Thus, it exhibits a local brightening effect. A gain value in the darkening region 226a, which is determined from a low image brightness value, is lower than that value. Consequently, it exhibits partially darkening effect. Because an image contrast ratio becomes higher, a viewer may easily recognize the image.

Ambient brightness or backlight brightness 232 may be respectively measured or controlled by other modules or units. For instance, the information of the ambient brightness may be obtained from an ambient light sensor (not shown). The backlight brightness 232 may be controlled by voltage.

A weighting proportion computation unit 230 is employed to determine a weighting proportion according to the ambient brightness or backlight brightness 232. The weighting proportion may be provided for determining a proportion of the basic value and a proportion of the gain value. Conventionally, readability would be declined under strong ambient light or low backlight. Therefore, the ambient brightness or the backlight brightness 232 should be served as one of variables herein while calculating the relative brightness of the fourth primary color 208.

The relative brightness computation unit of the fourth primary color 240 is connected to the basic value computation unit 210, the gain value computation unit 220, and the weighting proportion computation unit 230. Accordingly, the relative brightness of the fourth primary color 208 may be calculated according to the basic value, the gain value and the weighting proportion.

As mentioned above, the basic value is used to maintain original saturation. The gain value is provided for increasing brightness and an image contrast ratio. Under strong ambient light or low backlight, the proportion of the gain value should be increased so as to increase the relative brightness of the fourth primary color. Under adequate light conditions, it tends to maintain the proportion of the basic value to maintain the image saturation first.

In one embodiment, the relative brightness of the fourth primary color may be computed according to a formula mentioned below. Relative brightness of the fourth primary color=(1-weighting proportion)×(basic value)+(weighting proportion)×(gain value), in which the weighting proportion becomes higher when the ambient brightness becomes higher or the backlight brightness becomes lower. The weighting proportion has a value in the range of 0 to 1. Both the basic value and the gain value respectively have a value in the range of 0 to 255. Next section will describe how to use the formula to calculate the relative brightness of the fourth primary color 208 in consideration of the ambient brightness or backlight brightness.

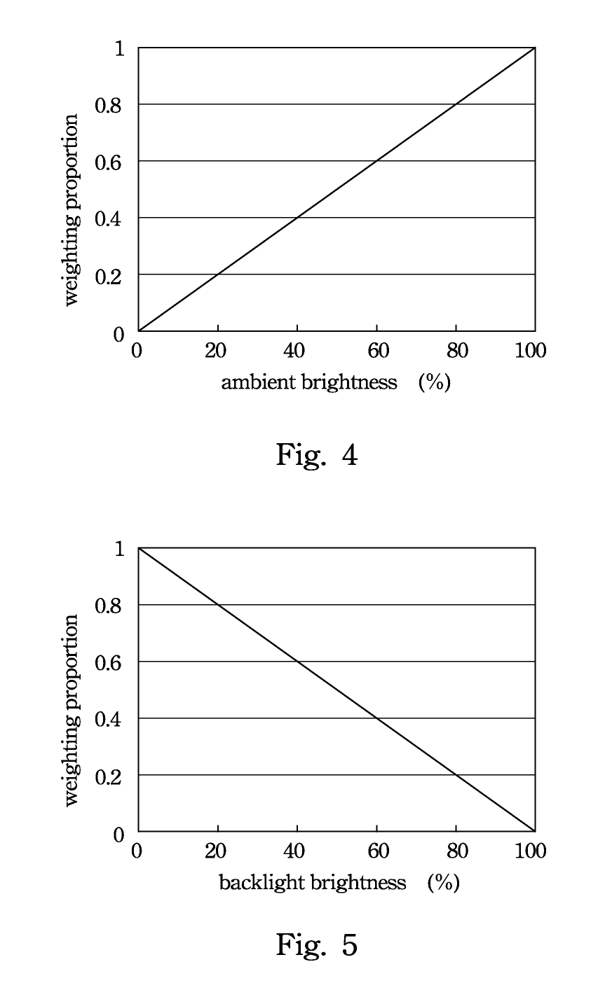

Taking the factor of ambient brightness into consideration, the weighting proportion may become higher with increasing ambient brightness. The ambient brightness is linear and in direct proportion to the weighting proportion, as shown in FIG. 4. Consequently, under strong ambient light, (weighting proportion)×(gain value) is higher than (1-weighting proportion)×(basic value) in the relative brightness of the fourth primary color calculated by the formula described above. It represents that the effect on the brightness of the gain value is greater than the basic value. In other words, a part of saturation is sacrificed in exchange for increasing the brightness. Therefore, such display device may exhibit good readability under strong ambient light.

Considering a case of backlight brightness, the weighting proportion may become higher with decreasing backlight brightness. The ambient brightness is linear and in inverse proportion to the weighting proportion, as shown in FIG. 5.

Therefore, under the circumstance of low backlight, which is similar to the condition of strong ambient light, (weighting proportion)×(gain value) is higher than (1-weighting proportion)×(basic value) in the relative brightness of the fourth primary color computed by the formula described above. It represents that the effect on the brightness of the gain value is greater than the basic value. In other words, a part of saturation is sacrificed in exchange for increasing the brightness. Thus, the display device may exhibit excellent readability under the low backlight such as in a power saving mode.

Another aspect of the present invention provides a method for calculating a relative brightness of a fourth primary color, which includes steps described below. A basic value is calculated. A gain value is calculated. A weighting proportion is determined, and relative brightness of a fourth primary color is calculated.

Firstly, the basic value and the gain value are respectively calculated according to the relative brightness of the three primary colors.

The basic value is a minimum value of the relative brightness of the three primary colors for maintaining a saturation of an image itself.

In one embodiment, an image brightness value is calculated, and the gain value is then determined. In one embodiment, the image brightness value may be computed according to Y=(3R+6G+B)/10. Y represents the image brightness value. R, G and B represent the relative brightness of the red primary color 202, the relative brightness of the green primary color 204, and the relative brightness of the blue primary color 206 respectively.

Next, the gain value is determined according to a relationship between the image brightness value and the gain value. The relationship may be linear or non-linear. In one embodiment, a relationship diagram between the image brightness value and the gain value is a non-linear sigmoid curve. As mentioned above with respect to FIG. 3, the sigmoid curve relationship may be provided for increasing a contrast ratio of an image.

The weighting proportion is then determined according to ambient brightness or backlight brightness. The information of the ambient brightness may be obtained from an ambient light sensor. The backlight brightness may be controlled by voltage.

Afterwards, the relative brightness of the fourth primary color is calculated according to the basic value, the gain value and the weighting proportion. In one embodiment, the relative brightness of the fourth primary color may be computed according to the formula described below. Relative brightness of the fourth primary color=(1-weighting proportion)×(basic value)+(weighting proportion)×(gain value), in which the weighting proportion becomes higher when the ambient brightness becomes higher or the backlight brightness becomes lower. The weighting proportion has a value in the range of 0 to 1. Both the basic value and the gain value respectively have a value in the range of 0 to 255.

As mentioned above, under conditions of strong ambient light or low backlight, saturation may be sacrificed for increasing brightness. Furthermore, a contrast ratio of an image (image contrast) may be increased for increasing recognizability of that image. As a result, the problem of low readability under strong ambient light or low backlight in conventional display devices may be improved.

Although the present invention has been described in considerable detail with reference to certain embodiments thereof, other embodiments are possible. Therefore, the spirit and scope of the appended claims should not be limited to the description of the embodiments contained herein.

It will be apparent to those ordinarily skilled in the art that various modifications and variations may be made to the structure of the present invention without departing from the scope or spirit of the invention. In view of the foregoing, it is intended that the present invention cover modifications and variations of this invention provided they fall within the scope of the following claims.

What is claimed is:

1. A four-primary color display comprising:
a plurality of pixels, each of the pixels having at least four sub-pixels for displaying a red primary color, a green primary color, a blue primary color and a fourth primary color respectively;
a relative brightness computation module of the fourth primary color for calculating relative brightness of the fourth primary color, the relative brightness computation module of the fourth primary color comprising:
a basic value computation unit for selecting a minimum value as a basic value among relative brightness of the red, the green and the blue primary colors;
a gain value computation unit for calculating a gain value according to the relative brightness of the red primary color, the green primary color and the blue primary color;
a weighting proportion computation unit for determining a weighting proportion of the basic value and the gain value according to ambient brightness or backlight brightness; and
a relative brightness computation unit of the fourth primary color for calculating the relative brightness of the fourth primary color according to the basic value, the gain value and the weighting proportion.

2. The four-primary color display device of claim 1, wherein the gain value computation unit comprises:
an image brightness value computation unit for calculating a image brightness value according to the relative brightness of the red, the green and the blue primary colors; and
a gain value decision unit for determining the gain value according to the image brightness value.

3. The four-primary color display device of claim 2, wherein the image brightness value computation unit calculates the image brightness value by the formula:
Y=(3R+6G+B)/10, wherein Y represents the image brightness value; R represents the relative brightness of the red primary color; G represents the relative brightness of the green primary color; and B represents the relative brightness of the blue primary color.

4. The four-primary color display device of claim 2, wherein the gain value determined by the gain value decision unit increases as the image brightness value increases, and a relationship diagram between the image brightness value and the gain value is a sigmoid curve.

5. The four-primary color display device of claim 1, wherein the relative brightness computation unit of the fourth primary color calculates the relative brightness of the fourth primary color by the formula:
relative brightness of the fourth primary color=(1—the weighting proportion)×(the basic value)+(the weighting proportion)×(the gain value), wherein the weighting proportion increases as the ambient brightness increases or the backlight brightness decreases.

6. The four-primary color display device of claim 1, wherein the four-primary color is a white primary color, a cyan primary color, a yellow primary color or a magenta primary color.

7. The four-primary color display device of claim 5, wherein the weighting proportion has a value ranging from 0 to 1, the basic value having a value ranging from 0 to 255, and the gain value has a value ranging from 0 to 255.

8. A method for calculating relative brightness of a fourth primary color, the method comprising the steps of:
calculating a basic value, wherein the basic value is a minimum value of relative brightness of red primary color, green primary color and blue primary colors;
calculating a gain value according to the relative brightness of the red, the green and the blue primary colors;
determining a weighting proportion of the basic value and the gain value according to ambient brightness or backlight brightness; and
calculating the relative brightness of the fourth primary color according to the basic value, the gain value and the weighting proportion.

9. The method of claim 8, wherein the step of calculating the gain value comprises the steps of:
calculating an image brightness value according to the relative brightness of the red, the green and the blue primary colors; and
determining the gain value according to the image brightness value.

10. The method of claim 9, wherein the step of calculating the image brightness value is based on the formula:
Y=(3R+6G+B)/10, wherein Y represents the image brightness value, R represents the relative brightness of the red primary color, G represents the relative brightness of the green primary color, and B represents the relative brightness of the blue primary color.

11. The method of claim 9, wherein the gain value determined by the gain value decision unit increases as the image brightness value increases, and a relationship diagram between the image brightness value and the gain value is a sigmoid curve.

12. The method of claim 8, wherein calculating the relative brightness of the fourth primary color is according to the formula:
relative brightness of the fourth primary color=(1-weighting proportion)×(basic value)+(weighting proportion)×(gain value), wherein the weighting proportion increases as the ambient brightness increases or the backlight brightness decreases.

13. The method of claim 8, wherein the four-primary color is a white primary color, a cyan primary color, a yellow primary color or a magenta primary color.

14. The method of claim 12, wherein the weighting proportion has a value ranging from 0 to 1, the basic value having a value ranging from 0 to 255, and the gain value has a value ranging from 0 to 255.
